(19) United States
(12) Patent Application Publication
(10) Pub. No.: US 2023/0004757 A1
(43) Pub. Date: Jan. 5, 2023

(54) DEVICE, MEMORY MEDIUM, COMPUTER PROGRAM AND COMPUTER-IMPLEMENTED METHOD FOR VALIDATING A DATA-BASED MODEL

(71) Applicant: Robert Bosch GmbH, Stuttgart (DE)

(72) Inventors: Armin Runge, Pittsburgh, PA (US); Christian Weiss, Leonberg (DE); Gor Hakobyan, Schoenaich (DE); Stefan Leidich, Rutesheim (DE)

(21) Appl. No.: 17/854,722

(22) Filed: Jun. 30, 2022

(30) Foreign Application Priority Data
Jul. 5, 2021 (DE) 10 2021 207 008.6
Jul. 8, 2021 (DE) 10 2021 207 246.1

(51) Int. Cl. G06K 9/62; G06N 5/02; G01S 7/41; G01S 7/48; G01S 13/931; G01S 17/931; G06V 20/56

(52) U.S. Cl. CPC G06K 9/6262; G06N 5/022; G01S 7/41; G01S 7/4802; G01S 13/931; G01S 17/931; G06V 20/56

(57) ABSTRACT

A device, a memory medium, a computer program, and a computer-implemented method for validating a data-based model for classifying an object into a class for an object type or a function type for a driver assistance system of a vehicle. The classification is determined as a function of a digital signal using the data-based model. A reference classification for the object is determined as a function of the digital signal, using a reference model. It is checked, as a function of the classification and the reference classification, whether or not the classification of the data-based model for the object is correct, and the data-based model is validated or not validated, depending on whether or not the classification is correct. The classification and the reference classification are determined for a set of digital signals that are associated with different distances between the object and a reference point.

### FIELD

The present invention relates to a device, a memory medium, a computer program, and a computer-implemented method for validating a data-based model.

### BACKGROUND INFORMATION

Driver assistance systems such as an emergency braking assistant and adaptive cruise control/cruise control systems may be implemented using video sensors and/or radar sensors. The objects encoded in data of these sensors may be recognized with the aid of object recognition and classified with the aid of object type recognition.

Data-based models may be used for the object type recognition. Use of a data-based model in safety-critical applications requires a validation of the data-based model and the creation of a representative data set, for example for the validation or a training of the data-based model.

### SUMMARY

A method and a device according to the present invention allow a validation of the data-based model and the creation of a representative data set for same.

According to an example embodiment of the present invention, a computer-implemented method for validating a data-based model for classifying an object, in particular into a class for an object type or a function type for a driver assistance system of a vehicle, provides that the classification is determined as a function of a digital signal, in particular a digital image, in particular a radar spectrum or a LIDAR spectrum or a segment of one of these spectra, using the data-based model, a reference classification for the object being determined as a function of the digital signal, using a reference model, it being checked, as a function of the classification and the reference classification, whether or not the classification of the data-based model for the object is correct, and the data-based model being validated or not validated, depending on whether or not the classification of the data-based model for the object is correct, the classification and the reference classification preferably being determined for a set of digital signals that are associated with different distances between the object and a reference point, in particular the vehicle or a sensor for detecting the set, for each digital signal from the set a measure of confidence, in particular a distance of the object from the reference point, being determined, and the data-based model being validated when the classification of the data-based model for the object in the digital signals is correct, whose measure of confidence meets a condition, in particular the condition that the distance is within a reference distance from the reference point. With increasing confidence, for example with decreasing distance, the reference model reliably recognizes the correct object type. For the validation of data-based models, a demonstration is to be made that the intended function is fulfilled. The method allows a statistical argument concerning various actual situations. Via the validation it is either demonstrated that the data-based model has not resulted in a wrong decision or its decisions were even better than those of the reference model, or it is established that this is not the case. The use of the measure of confidence allows a particularly reliable validation.

According to an example embodiment of the present invention, it may be provided that the set of digital signals and the reference classification are stored in association with one another when the measure of confidence meets the condition, in particular the distance is within the reference distance, and the classification deviates from the reference classification, and the digital signal is otherwise discarded and/or not stored. In this way a misclassification is recognized, and a data set that is particularly well suited for a training is created with little complexity.

For the set, a value pair that includes a first value and a second value is preferably determined, the first value indicating a distance within which the reference classification for the object is correct, the second value indicating either a distance within which the classification of the data-based model for the object is correct, or a spacing of this distance from the reference distance. The data-based model is to correctly classify the object at least within the same distance as the reference model. The first value and the second value include the information necessary for this purpose, and are also variables that are easily evaluatable in the validation.

According to an example embodiment of the present invention, for the value pair, a memory location in a memory is preferably determined, a value that is stored at this memory location being changed as a function of the values of the value pair. Instead of storing the first value and the second value themselves, only one value is stored. This is a particularly efficient way of storing cumulative information concerning the variables that are particularly easily evaluatable for the validation.

The data-based model is preferably validated as a function of the value that is stored at this memory location.

According to an example embodiment of the present invention, for a plurality of sets of digital signals, their classifications and their reference classifications are preferably determined, and it is checked whether or not the classification of the data-based model for the object is correct. The digital signals represent sequences of individual recordings that result at different distances upon an approach toward an object. The recordings may be radar, LIDAR, or video recordings or their spectra. The recordings may also be signals that are derived from same. Spectra are one option, but point clouds or other derived signals may also be used. The classifications of the plurality of sets of digital signals represent classifications for a large number of such approaches. A statistically relevant quantity of various situations is thus ensured for reliably validating the data-based model.

It may be provided that for each set from the plurality of sets, a value pair that includes a first value and a second value for the particular set is determined, for each set a memory location for the value pair determined for this set being determined, and a value stored at this memory location being changed as a function of the values of the value pair. A statistically relevant quantity of results with which the data-based model is validated is thus provided.

It may be provided that for each digital signal, a position is detected and/or stored in particular using a system for satellite navigation, the distance being determined as a function of the position. Region-specific relevant data may thus be determined.

It may be provided that when the validation of the data-based model fails, the data-based model is retrained or trained with different data, and/or some other data-based model is used.

It may be provided that when the validation of the data-based model is successful, the data-based model is used in a system for classifying objects, in particular in the driver assistance system.

According to an example embodiment of the present invention, a device for validating a data-based model for classifying an object includes at least one processor and at least one memory that are designed to carry out the method.

According to an example embodiment of the present invention, a computer program may be provided that includes machine-readable instructions, the method running when the machine-readable instructions are executed by a computer.

According to an example embodiment of the present invention, a memory medium, in particular a permanent memory medium on which the computer program is stored, may be provided.

Further advantageous specific embodiments of the present invention result from the description below and the figures.

### BRIEF DESCRIPTION OF THE DRAWINGS

FIG. 1 shows a device according to an example embodiment of the present invention.

FIG. 2 shows a schematic illustration of an object type recognition, according to an example embodiment of the present invention.

FIG. 3 (which includes FIGS. 3A and 3B) shows an example of the method according to the present invention.

FIG. 4 shows an array with entries for the validation, according to an example embodiment of the present invention.

FIG. 5 shows an example approach toward an object.

### DETAILED DESCRIPTION OF EXAMPLE EMBODIMENTS

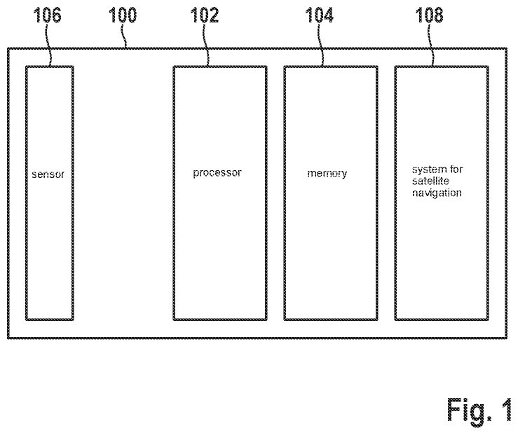

A device 100 for validating a data-based model is schematically illustrated in FIG. 1. The data-based model is designed for classifying an object. Device 100 includes at least one processor 102 and at least one memory 104. Device 100 optionally includes at least one sensor 106 and a system 108 for satellite navigation.

In the example, the at least one memory 104 includes a working memory and a permanent memory. In the example, the working memory allows faster access compared to the permanent memory.

In the example, the at least one sensor 106 includes a radar sensor. The radar sensor emits high-frequency signals and receives reflections of static objects and moving objects. The signals are received with the aid of antennas of the radar sensor, changed into electrical signals by an electronics system, and converted into digital signals with the aid of analog-digital converters. The time signals are transferred into the frequency space with the aid of primary signal processing such as FFT.

In the example, the at least one processor 102 and the at least one memory 104 are connected via a data link. The at least one sensor 106 and/or system 108 are/is connected to a data link for communicating with the at least one processor 102. The at least one sensor 106 and/or the system may be connected to this data link from outside device 100, or may have a design that is integrated into device 100.

The at least one processor 102 and the at least one memory 104 are designed to carry out an object recognition, an object type recognition, and the method or steps therein described below.

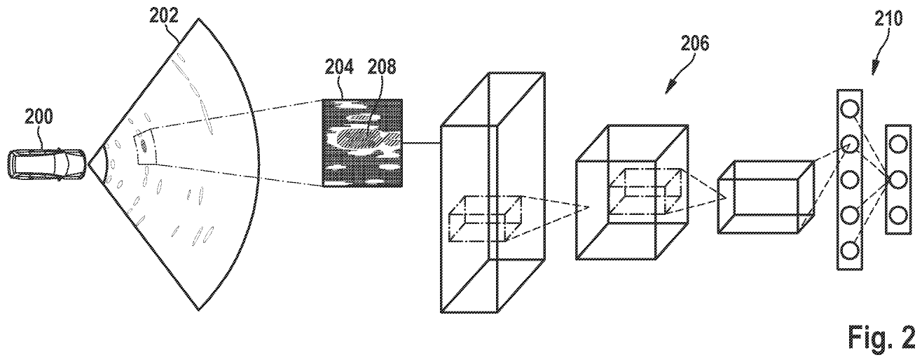

A schematic illustration of the object type recognition is depicted in FIG. 2.

In the example, device 100 is situated in a vehicle 200. A spectrum 202 of the signal received from at least one radar sensor 106 is provided for the object type recognition. In the example, the object type recognition is carried out on a segment 204 of spectrum 202, using a data-based model 206. In the example, data-based model 206 includes an artificial neural network designed as a convolutional neural network, for example.

In the example, segment 204 includes an object 208. In the example, an object type 210 of object 208 is determined using data-based model 206.

The object recognition, within the meaning of which an object is present or not present in segment 204, may take place in various ways. For example, a threshold value detector may be used. A distance of a recognized object from the sensor is recognizable via propagation time measurements or phase shifts, for example.

In the example, the object recognition and the object type recognition are used for driver assistance.

The quality of the object type recognition is essential for the quality of the driver assistance. The object type recognition may be designed to recognize the following object types: passenger car, bicycle, pedestrian, manhole cover. The passenger car, bicycle, and pedestrian object types may be assigned to a class “may not be driven over.” The manhole cover object type may be assigned to a class “may be driven over.” The object type recognition may also be designed to recognize other object types. Other classes may also be provided. For example, a class is provided for each object type.

The quality of the object type recognition is measured, for example, by the correctness of the object type recognition over a distance from the object to be recognized. The greater the distance for a correct recognition, the better is the quality, for example, since the driving behavior may thus be adapted early to a recognized situation.

The object type recognition may be technically implemented in various ways. In the example, data-based model 206 is designed as an artificial neural network. Data-based model 206 to be validated may also be part of a hybrid model. In this case, “hybrid model” refers to a combination of conventional signal processing and data-based model 206. A conventional signal processing concept or some other data-based model that is already established may be used as a reference model for a validation of data-based model 206.

The reference model may also be a hybrid model, i.e., a combination of conventional signal processing and at least one data-based model.

The validation of data-based model 206 may take place by comparing the results achieved using data-based model 206 to the results achieved using the reference model. The reference model preferably has a certain demonstrable classification quality.

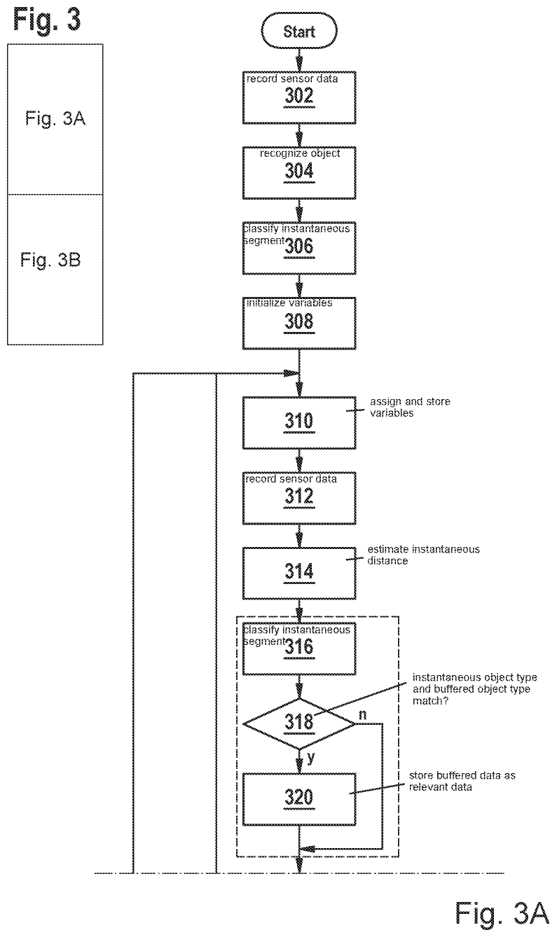

An example of a sequence of the method is described with reference to FIG. 3 (which includes FIGS. 3A and 3B). The method makes use of the fact that the quality of classification at a close range is greater than that at a farther distance. An actual object type of detected objects is not subject to a temporal change. It is thus possible within the scope of an approach, i.e., travel of vehicle 200 toward the real object, to utilize changes that occur in the recognized object types in order to determine the quality and to identify data that are relevant for a training. The recordings which at a large distance result in a classification result that deviates from the classification result at the close range are relevant. The close range is, for example, a distance of the real object from vehicle 200 or from at least one sensor 106 that is between 3 meters and 30 meters. Beyond this distance, it may be assumed that the object type predicted by the reference model is correct based on the convergence property of the reference model.

For cost reasons, the method according to the present invention is designed in such a way that a necessary data memory having a quick access time, in the example the working memory, is small.

The method starts, for example, with a first-time recognition of an object by the object detector.

Sensor data of a sensor are recorded in a step 302. In the example, the sensor is a radar sensor. The function obtains new sensor data in this way. A spectrum is determined using the sensor data. In the example, a frame that includes the spectrum is determined.

A step 304 is subsequently carried out.

The object is recognized in step 304. For example, the object in the spectrum is recognized.

An instantaneous segment of the spectrum is determined in step 304. In the example, the segment is a detail from the spectrum that includes the object. The instantaneous segment is stored in a variable S_akt. In the example, a frame that includes the instantaneous segment is stored in variable S_akt.

An instantaneous distance is estimated in step 304. In the example, the distance is the distance of the sensor from the object. The instantaneous distance is stored in a variable d_akt.

A step 306 is subsequently carried out.

Instantaneous segment S_akt is classified on the one hand using a data-based model 206, and on the other hand using a reference model, in step 306.

A classification result of the reference model is stored in a variable for an instantaneous object type OT_akt_base. A classification result of the data-based model to be validated is stored in a variable for an instantaneous object type OT_akt_val. The reference model may include an established object recognition algorithm. The data-based model may include an algorithm to be validated.

A step 308 is subsequently carried out.

Variables that are used in the further process are initialized in step 308.

For the data-based model, a variable for a relevant object type OT_rel_val, a variable for a relevant segment S_rel_val, and a variable for a relevant distance d_rel_val are initialized.

For the reference model, a variable for a relevant object type OT_rel_base, a variable for a relevant segment S_rel_base, and a variable for a relevant distance d_rel_base are initialized. In addition, a variable “entries” for a number of entries is initialized. In the example, the variables are assigned and stored as follows:

OT_rel_base=OT_akt_base

OT_rel_val=OT_akt_val

S_rel_base=S_akt

S_rel_val=S_akt

d_rel_base=d_akt

d_rel_val=d_akt

entries=0

A step 310 is subsequently carried out.

Step 310 represents a beginning of a main loop.

The following variables are assigned and stored as follows in step 310:

OT_old_base=OT_akt_base

OT_old_val=OT_akt_val

S_old_base=S_akt

S_old_val=S_akt

d_old_base=d_akt

d_old_val=d_akt

For the data-based model, the instantaneous object type is stored in a variable OT_old_val, the instantaneous sequence is stored in a variable S_old_val, and the instantaneous distance is stored in a variable d_old_val.

For the reference model, the instantaneous object type is stored in a variable OT_old_base, the instantaneous sequence is stored in a variable S_old_base, and the instantaneous distance is stored in a variable d_old_base.

A step 312 is subsequently carried out.

Sensor data of the sensor are recorded in a step 312. The function obtains new sensor data in this way. A spectrum is determined using the sensor data. In the example, a frame that includes the spectrum is determined.

An instantaneous segment of the spectrum is determined in step 314. In the example, the segment is a detail from the spectrum that includes the object. The instantaneous segment is stored in a variable S_akt. In the example, a frame that includes the instantaneous segment is stored in variable S_akt.

An instantaneous distance is estimated in step 314. In the example, the distance is the distance of the sensor from the object. The instantaneous distance is stored in variable d_akt.

A step 316 is subsequently carried out.

Instantaneous segment S_akt is classified in step 316, using the reference model. A classification result of the reference model is stored in the variable for instantaneous object type OT_akt_base.

A step 318 is subsequently carried out.

For the reference model it is checked in step 318 whether or not the instantaneous object type and the buffered object type match. In the example, it is checked whether object type OT_akt_base!=object type OT_old_base.

If the object types do not match, a step 320 is carried out. Otherwise, a step 322 is carried out.

A change between the object types may be recognized via the comparison between the object types.

The buffered data are stored as relevant data in step 320, i.e., when a change takes place. In the example, the variables are assigned and buffered as follows:

OT_rel_base=OT_old_base

S_rel_base=S_old_base

d_rel_base=d_old_base.

If the object types are the same, the previously buffered relevant data are retained. The relevant data are preferably stored in the working memory, for example a volatile memory.

Instantaneous segment S_akt is classified in step 322, using data-based model 206.

A classification result of the data-based model to be validated is stored in the variable for instantaneous object type OT_akt_val.

A step 324 is subsequently carried out.

For the data-based model to be validated, it is checked in step 324 whether or not the instantaneous object type and the buffered object type match. In the example, it is checked whether object type OT_akt_val!=object type OT_old_val.

If the object types do not match, a step 326 is carried out. Otherwise, a step 328 is carried out.

A change between the object types may be recognized via the comparison between the object types.

The buffered data are stored as relevant data in step 326, i.e., when a change takes place. In the example, the variables are assigned and stored as follows:

OT_rel_val=OT_old_val

S_rel_val=S_old_val

d_rel_val=d_old_val.

If the object types are the same, the previously stored relevant data are retained.

A comparison is made between the instantaneous distance from the object and a threshold value in step 328. For example, it is checked whether d_akt<SHORTDIST, where SHORTDIST is a stored constant. In the example, constant SHORTDIST is a value that represents a distance between 3 m and 30 m. In the example, it is checked whether the object is situated in the close range. In the close range, the object recognition using the reference model, i.e., using the established algorithm, is deemed reliable. If the close range is not reached, the main loop is executed anew, beginning with step 310.

It may be provided that in step 328 it is also checked whether a predefined time has elapsed since the most recent execution of an update of the relevant data. If this is not the case, in the example the main loop is executed anew, beginning with step 310, regardless of whether or not the close range is reached.

For example, an instantaneous time is determined, and a difference between the instantaneous time and the most recent point in time at which the update took place is determined, in step 328. The instantaneous time is determined using a function time_now( ) for example. The most recent point in time at which the update took place is stored in a variable lastUpdate, for example. This variable is initialized, for example, in a first iteration using zero.

In the example, a step 330 is carried out when the close range is reached and the difference is greater than a threshold value. The threshold value is a constant RETRIGGER, for example. Constant RETRIGGER may be a time from a range between 10 ms and 1 s. Otherwise, step 310 is carried out in the example.

The most recent point in time at which the update took place is set to the value of the instantaneous time in step 330. In the example, lastUpdate=time now( ) is set.

When the close range is reached and the actual object type has thus been identified, it may be provided to store the relevant data of the algorithm to be validated and/or to insert an entry into a validation array.

An example of a procedure for storing the relevant data of the algorithm to be validated is referred to below as corner case detection.

An example of a procedure for inserting an entry into the validation array is referred to below as validation.

In the example, both processes run in parallel, and are explained in greater detail below. After step 330, in the example step 332 is carried out at the start of the corner case detection, and step 336 is carried out at the start of the validation.

Corner Case Detection:

It is basically assumed that the segment stored in S_rel_val is relevant. It is assumed that the algorithm to be validated likewise has a higher classification quality for fairly short distances. However, it is not a necessary condition that the algorithm already delivers a reliable classification when the close range, in the example d_akt<SHORTDIST, has been reached.

It is checked in step 332 whether or not the object type, which has been recognized using the reference model, matches the object type from the relevant data for data-based model 206 to be validated. For example, it is checked whether OT_rel_val!=OT_akt_base. If both object types agree, the main loop is executed, beginning with step 310. Otherwise, a step 334 is carried out. It is thus ensured that no segments are stored for which data-based model 206 to be validated has already classified the correct object type in a previous iteration, but has then changed to an incorrect object type.

The relevant data are stored in step 334. The relevant data are preferably stored in the permanent memory in step 334.

If the object types differ, a relevant segment has been identified, and the corresponding relevant data are stored for later use.

In the example, after step 334 the main loop is executed, beginning with step 310.

It may be provided that in a parallel task, not illustrated in FIG. 3, the data stored in the permanent memory are transferred into a computer infrastructure as soon as a sufficient quantity of relevant data is present.

The arrival of new data from the permanent memory in the computer infrastructure may initiate a training operation.

In the example, a new data-based model 206 is determined in the training operation. It may be provided that this model is compiled to form new firmware and is provided to the sensor via over-the-air firmware, for example. It may be provided to activate the new firmware in the sensor, reinitialize the variables, and start the method anew.

Validation:

In the example, the validation is used to establish whether or not data-based model 206 is suitable for its intended purpose.

Situations in which data-based model 206 to be validated has not been able to classify the correct result play a special role in the validation.

It is checked in a step 336 whether or not this situation is present. In the example, it is checked whether OT_akt_val!=OT_akt_base. If this situation is present, a step 338 is carried out. Otherwise, a step 340 is carried out.

In the example, a ccc value for OTC_val is set to 0 in step 338, since d_rel_val in this case belongs to the most recent change of the object type, but not to the correct object type. Step 340 is subsequently carried out.

An important metric for the quality of an object recognition algorithm is a distance at or above which it has been continuously possible to correctly classify the object. This is referred to as continuous correct classification (ccc). In the example, the ccc value is determined using a function ccc(⋅). For the reference model, the ccc value is determined using a function ccc(OTC_base). For data-based model 206 to be validated, the ccc value is determined using a function ccc(OTC_val). In the example, the reference model has a demonstrably sufficient classification quality. For data-based model 206 to be validated, in the example it is to be shown that in all relevant situations and below a distance limit DIST REL, the model has a ccc value that is at least as great as the reference model.

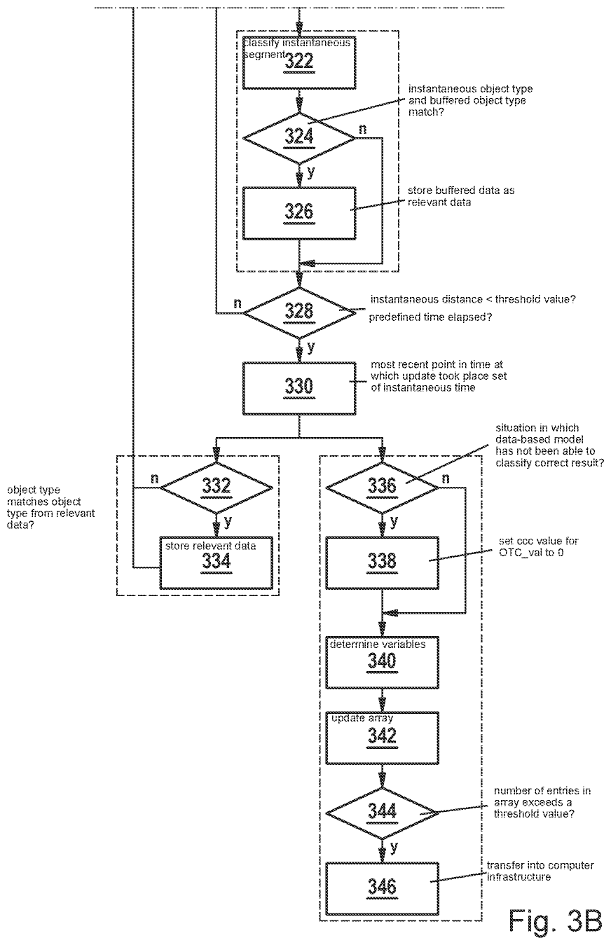

To allow this demonstration to be made, the ccc value of the reference model and difference Δccc between the ccc value for the reference model and the ccc value of data-based model 206 to be validated are stored in a two-dimensional array. This array may be represented as illustrated in FIG. 4.

Difference Δccc in meters is illustrated across an x axis. A range from −200 meters to +200 meters is illustrated in FIG. 4. A plurality of ranges are defined on the x axis. A range has an extension 402, referred to below as BIN_SIZE, in the x direction.

The ccc value for the reference model is illustrated in meters across a y axis. A range from 0 meters to 200 meters is illustrated in FIG. 4. In the example, the close range is reached at a boundary 404 at a distance DIST_REL that is less than or equal to 150 meters, for example.

To allow the array to be efficiently stored, the ccc values are assigned to individual BINs. Each BIN has a size of BIN_SIZE. Accordingly, the array has a size of (200*2/BIN_SIZE)×(200/BIN_SIZE), for example, and an entry for ccc(OTC_base), ccc(OTC_val) results in an increment of the array at the following (x, y) position of the array:

$$( ⌊ \frac{ccc ( OTC \_base ) - ccc ( OTC \_ val )}{BIN\_SIZE} ⌋ , ⌊ \frac{ccc ( OTC \_base )}{( BIN\_SIZE )} ⌋ )$$

Since for distances less than distance 404, data-based model 206 to be validated must have at least the classification quality of the established reference model, all entries in a range of 0<x <200 and 0<y<DIST REL are to be smaller than a threshold, preferably 0. This is a range at the lower right side in FIG. 4. Entries in this range mean that the difference between ccc(OTC_base) and ccc(OTC_val) was positive, and data-based model 206 to be validated thus has a poorer ccc value. ccc(OTC_base) and ccc(OTC_val) represent a value pair. The value pair includes a first value ccc(OTC_base), which represents a distance within which the reference classification for the object is correct. The value pair includes a second value ccc(OTC_val), which represents a distance within which the classification of data-based model 206 for the object is correct. The difference ccc(OTC_base)−ccc(OTC_val) represents a spacing of this distance from the reference distance.

In contrast, entries in which −200<x≤0 and 0<y<DIST_REL are to assume high values. This is a range at the lower left side in FIG. 4. Entries in this range mean that data-based model 206 to be validated has a higher ccc value than the established reference model.

For distances greater than or equal to DIST_REL, a higher classification quality of data-based model 206 to be validated is likewise desirable, but not absolutely necessary.

The following variables are determined in each case for the relevant data in step 340:

bin_ _rel_base−d_rel_val

bin_val=floor (delta/BIN_SIZE)

A step 342 is subsequently carried out.

The array is updated in step 342. For example, a function ccc_matrix(bin_bas, bin_val)++ is executed. This function increments the entries in the array by one at the locations that are defined by bin_bas and bin_val. In this way, a value stored at this memory location is changed as a function of the values of the value pair.

In addition, in the example a number of entries in the array are counted. In the example, the variable “entries” is incremented by one: entries++

A step 344 is subsequently carried out.

It is checked in step 344 whether the number of entries in the array exceeds a threshold value. In the example, it is checked whether the variable “entries” >MAX_ENTRIES. If the number of entries exceeds the threshold value, a step 346 is carried out. Otherwise, the validation is ended.

The array thus generated when MAX_ENTRIES is exceeded is transferred into the computer infrastructure in step 346.

The array is an efficient representation of the ccc values. It may be provided that data-based model 206 is validated using the array.

The validation subsequently ends.

It may be provided that when the validation of data-based model 206 fails, data-based model 206 is retrained or trained with different data, and/or some other data-based model is used.

It may be provided that when the validation of data-based model 206 is successful, data-based model 206 is used in a system for classifying objects, in particular in the driver assistance system.

It may be provided that this method is carried out by multiple vehicles. It may be provided that data-based model 206 is validated using the arrays of these vehicles.

These arrays are used, for example, for a statistical validation of data-based model 206.

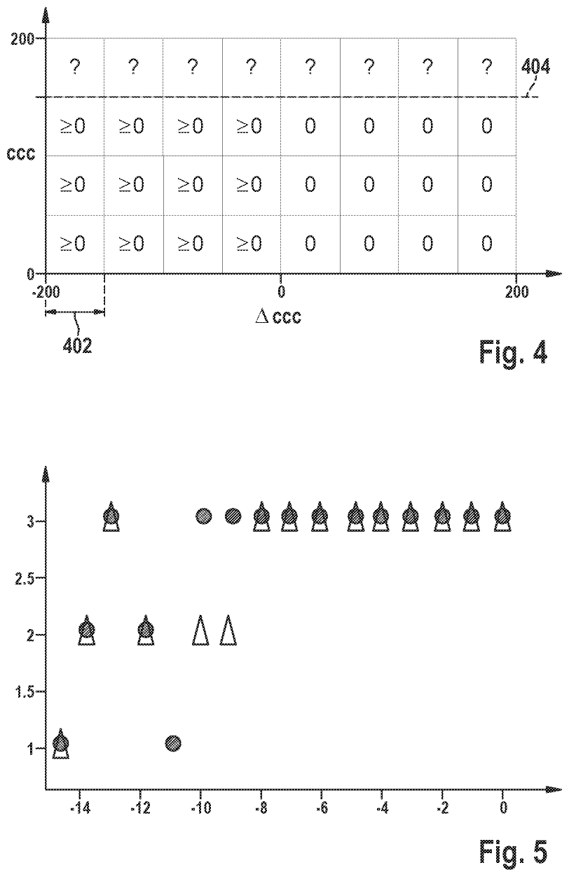

An example approach toward an object is schematically illustrated in FIG. 5. The x axis shows a distance from the object in negative values. The object type is plotted on the y axis. In the example, this is an object having the arbitrarily selected object type class 3.

An object type that is predicted with the aid of the established reference model is illustrated as a triangle for various distances. An object type that is predicted with the aid of data-based model 206 to be validated is illustrated as a circle for various distances.

In this example, the reference model continuously correctly classifies the object starting at a distance of 8 m. Data-based model 206 to be validated already continuously correctly classifies the object starting at 10 m.

In this example, when the close range is reached, at a distance of 8 meters in the example, the correct object type is identified and the most recent misclassification by the data-based model to be validated for a distance of 11 m is transferred. In this example, ccc(OTC_base)=8 and ccc(OTC_val) =10. This results in an incrementation of the validation array at (8, −2).

An identification of data for which data-based model 206 to be validated has classified an incorrect object type may be provided. These data are data, for example, which the established reference model has classified differently. These data are of particular importance for a training of data-based model 206, for example a neural network for the classification, since they reveal a weak point of the object recognition in the particular instantaneous state.

Instead of using distance d_akt and threshold value SHORTDIST to decide that data-based model 206 to be validated has correctly classified the object, additionally or alternatively a measure of confidence of the object recognition by the reference model may be used. This measure of confidence is, for example, provided by the reference model, and may be based, for example, on a duration of a stable classification by the reference model.

It may also be provided to determine a ccc distance for the reference model and data-based model 206 to be validated for an increasing distance from the object. If an object, which was situated in a range in which a continuously correct classification was possible, subsequently moves out of this range, for example the ccc distance at or above which the ccc is no longer possible is determined. The above-described procedure is followed for this purpose. In this case, the corner case detection may likewise be carried out.

Instead of using the distance from the classified object as a measure for a reliable classification result of the established reference model, some other measure of confidence may be used. For example, the classification result of the established reference model may be regarded as reliable when, for a certain time period greater than a threshold value, for example t_stable, a stable, i.e., unchanging, classification result was present. Thus, follow-up trips without a close approach may also be used for the validation, regardless of the distance from the object.

The example of object classification is based on segments of spectra. Instead of segments of spectra, the object classification may also be based on other input variables. For example, the procedure may also be used for a location-based object recognition algorithm that replaces or supplements the object classification that is based on the segments of spectra. In this case, the corresponding data, i.e., the positions instead of the spectra, are stored as relevant data.

In the example described above, for the corner case detection it is checked whether the object types, in the example OT_rel_val and OT_akt_base, are different in order to ensure that no data that have resulted in the correct classification are stored in the permanent memory. Instead, it may be provided when there is a disparity in the recognized object types, in the example of OT_akt_base and OT_akt_val, it is not the object type, in the example OT_rel_val, that was previously recognized by the reference model that is stored in the permanent memory, but, rather, the object type, in the example OT_akt_val, that is recognized at that moment by the reference model. This is advantageous, since data-based model 206 in this case also delivers an incorrect classification result for the instantaneous segment.

It may be provided that particular GPS positions of the data detection are stored in addition to the stated data. These GPS positions may be provided by the vehicle via a bus system. With the aid of the GPS positions, data are provided with which it is possible to train data-based model 206 on a region-specific basis.

A comparison of the object types may be replaced by other functions such as an intervention of an automatic emergency brake or an automatic emergency evasive maneuver. This means that a response of the function to the particular recognized object type is used.

1-13 (canceled)

14. A computer-implemented method for validating a data-based model for classifying an object into a class for an object type or a function type for a driver assistance system of a vehicle, the method comprising the following steps:
determining the classification as a function of a digital signal, using the data-based model, the digital signal being a digital image or a radar spectrum or a LIDAR spectrum or a segment of a radar spectrum or a segment of a LIDAR spectrum;
determining, using the data-based model, a reference classification for the object as a function of the digital signal;
checking, using a reference model, as a function of the classification and the reference classification, whether or not the classification of the data-based model for the object is correct; and
validating or not validating the data-based model, depending on whether or not the classification of the data-based model for the object is correct;
wherein the classification and the reference classification are determined for a set of digital signals that are associated with different distances between the object and a reference point, and wherein for each digital signal from the set, a measure of confidence is determined, and the data-based model being validated when the classification of the data-based model for the object in the digital signals is correct, whose measure of confidence meets a condition, wherein the measure of confidence is a distance of the object from the reference point, and wherein the condition is that the distance is within a reference distance from the reference point.

15. The method as recited in claim 14, wherein the reference point is the vehicle or a sensor for detecting the set of digital signals.

16. The method as recited in claim 14, wherein the set of digital signals and the reference classifications are stored in association with one another when the measure of confidence meets the condition and the classification deviates from the reference classification, and the digital signals are otherwise discarded and/or not stored.

17. The method as recited in claim 14, wherein for the set, a value pair that includes a first value and a second value is determined, the first value indicating a distance within which the reference classification for the object is correct, and the second value indicating a distance within which the classification of the data-based model for the object is correct, or a spacing of the distance from the reference distance.

18. The method as recited in claim 17, wherein for the value pair, a memory location in a memory is determined, a value that is stored at the determined memory location being changed as a function of the values of the value pair.

19. The method as recited in claim 18, wherein the data-based model is validated as a function of the value that is stored at the determined memory location.

20. The method as recited in claim 14, wherein, for a plurality of sets of digital signals, their classifications and their reference classifications are determined, and it is checked whether or not the classification of the data-based model for the object is correct.

21. The method as recited in claim 20, wherein for each set from the plurality of sets, a value pair that includes a first value and a second value for the set is determined, for each set, a memory location for the value pair determined for the set is determined, and a value stored at the determined memory location is changed as a function of the values of the value pair.

22. The method as recited in claim 14, wherein for each digital signal, a position is detected and/or stored using a system for satellite navigation, the distance being determined as a function of the position.

23. The method as recited in claim 14, wherein when the validation of the data-based model fails: (i) the data-based model is retrained or trained with different data, and/or (ii) a different data-based model is used.

24. The method as recited in claim 14, wherein when the validation of the data-based model is successful, the data-based model is used in a system for classifying objects in the driver assistance system.

25. A device for validating a data-based model for classifying an object, the device comprising:
at least one processor; and
at least one memory;
wherein the device is configured to:
determine a classification of the object as a function of a digital signal, using the data-based model, the digital signal being a digital image or a radar spectrum or a LIDAR spectrum or a segment of a radar spectrum or a segment of a LIDAR spectrum;
determine, using the data-based model, a reference classification for the object as a function of the digital signal;
check, using a reference model, as a function of the classification and the reference classification, whether or not the classification of the data-based model for the object is correct; and
validate or not validate the data-based model, depending on whether or not the classification of the data-based model for the object is correct;
wherein the classification and the reference classification are determined for a set of digital signals that are associated with different distances between the object and a reference point, and wherein for each digital signal from the set, a measure of confidence is determined, and the data-based model being validated when the classification of the data-based model for the object in the digital signals is correct, whose measure of confidence meets a condition,
wherein the measure of confidence is a distance of the object from the reference point, and wherein the condition is that the distance is within a reference distance from the reference point.

26. A non-transitory memory medium on which is stored a computer program for validating a data-based model for classifying an object into a class for an object type or a function type for a driver assistance system of a vehicle, the computer program, when executed by a computer, causing the computer to perform the following steps:
determining the classification as a function of a digital signal, using the data-based model, the digital signal being a digital image or a radar spectrum or a LIDAR spectrum or a segment of a radar spectrum or a segment of a LIDAR spectrum;
determining, using the data-based model, a reference classification for the object as a function of the digital signal;
checking, using a reference model, as a function of the classification and the reference classification, whether or not the classification of the data-based model for the object is correct; and
validating or not validating the data-based model, depending on whether or not the classification of the data-based model for the object is correct;
wherein the classification and the reference classification are determined for a set of digital signals that are associated with different distances between the object and a reference point, and wherein for each digital signal from the set, a measure of confidence is determined, and the data-based model being validated when the classification of the data-based model for the object in the digital signals is correct, whose measure of confidence meets a condition, wherein the measure of confidence is a distance of the object from the reference point, and wherein the condition is that the distance is within a reference distance from the reference point.
